(19) United States
(12) Patent Application Publication
(10) Pub. No.: US 2012/0167397 A1
(43) Pub. Date: Jul. 5, 2012

(54) ROPE-CONTROLLED STRUCTURE FOR EXTENDED REACH GARDEN SHEARS

(75) Inventor: Yao-Chung Huang, Fu Shing Hsiang (TW)

(73) Assignee: HO CHENG GARDEN TOOLS CO., LTD., FU SHING HSIANG (TW)

(21) Appl. No.: 12/984,592

(22) Filed: Jan. 4, 2011

(51) Int. Cl. A01G 3/08

(52) U.S. Cl. 30/249

(57) ABSTRACT

Extended reach garden shears include an extension rod, a handgrip, a cutting head and a pull handle. The extension rod is formed with an accommodating space, a front opening and a rear opening. The extension rod is provided with a pin hole and a rope-guiding hole. The handgrip is slidingly disposed on the extension rod. The cutting head is inserted into the front opening. The pull handle is inserted into the rear opening. A fixed base is fixed in the accommodating space. A movable base is slidingly disposed in the accommodating space and connected to the cutting head. A rope has a combining end, a connecting end and a wrapping section. The wrapping section wraps around the fixed base and the movable base. The combining end is connected to the pull handle. The connecting end is connected to the pull handle. The rope, the fixed base and the movable base enable the garden shears to achieve an efficient trimming action.

### BACKGROUND OF THE INVENTION

1. Field of the Invention

The present invention relates to extended reach garden shears, and in particular to a rope-controlled structure for extended reach garden shears.

2. Description of the Prior Art

When people intend to trim branches or leaves in a tall tree, they often use extended reach garden shears to perform the trimming operation. FIG. 8 shows conventional extended reach garden shears having an extension rod 50. The top end of the extension rod 50 is connected to a cutting head 60. The extension rod 50 is provided with a sliding handgrip 51. The sliding handgrip is connected to a rope 52. The extension rod 50 is formed with a rope-guiding portion 53. The rope 52 is disposed through the rope-guiding portion 53 to enter the extension rod 50 and to extend towards the cutting head 60 along the interior of the extension rod 50. The cutter head 60 is provided with a through-hole 54 through which the rope 52 exits. The cutting head 60 is pivotally connected to a fixed blade 61 and a movable blade 62. One end of the movable blade 62 is connected to a spring 63, and the other end of the movable blade 62 is provided with a roller 64. The rope 52 wraps around the roller 64 and is fixed to the fixed blade 61. When the user pulls the sliding handgrip 51, the sliding handgrip 51 pulls the rope 52 downwards to drive the movable blade 62, thereby performing the trimming action.

However, the above-mentioned conventional garden shears have the following problems.

(I) One end of the rope 52 is connected to the sliding handgrip 51, and the other end of the rope 52 wraps around the roller 64 to be fixed to the fixed blade 61 of the cutting head 60. The cutting head 60 is driven by the rope 52, and the rope 52 is pulled by the sliding handgrip 51. The force exerted by the user is transmitted by the rope 52 and the cutting head 60 without any savings of labor. As a result, the user has to pull the sliding handgrip 51 with a greater force, which makes the trimming action difficult.

(II) After the trimming action is completed, the sliding handgrip 51 returns to its original position by means of the elastic force of the spring 63. At this time, the sliding handgrip 51 is only stopped by the rope-guiding portion 53 through which the rope 52 is disposed. As a result, the rope-guiding portion 53 can collide with the sliding handgrip 51 and suffer damage thereby, which makes the operation of the extended reach garden shears rough.

In view of the above, the present inventor proposes a novel structure based on his expert experience and considered research in this field.

### SUMMARY OF THE INVENTION

In order to solve the above problems, an objective of the present invention is to provide a rope-controlled structure for extended reach garden shears.

In order to achieve the above objective, the present invention provides a rope-controlled structure for extended reach garden shears. The extended reach garden shears are provided with an extension rod. The extension rod is provided with a fixed base and a movable base. The fixed base is provided with a plurality of rollers, and the movable base is provided with a plurality of pulleys. A rope wraps around the rollers of the fixed base and the pulleys of the movable base. The pulling of the rope causes the movable base to slide. In this way, a cutting head of the extended reach garden shears performs a trimming action. The connection among the rope, the fixed base and the movable base controls the trimming action of the extended reach garden shears in a labor-saving manner.

According to another feature of the present invention, the extension rod is fixedly provided with a restricting sleeve, and the restricting sleeve is provided with a guide hole through which the rope is disposed. The guide hole of the restricting provides a smoother action for the handgrip when pulling the rope. The restricting sleeve is stopped between the rope-guiding hole and the handgrip, thereby restricting the moving distance of the handgrip and facilitating usage of the present invention.

According to another feature of the present invention, when the fixed base is disposed into the extension rod, a protrusion on the fixed base engages with a locking hole in the extension rod, so that a through-hole of the fixed base aligns with a pin hole of the extension rod. In this way, a pin can be disposed through the pin hole and the through-hole easily, thereby facilitating assembly of the present invention.

### BRIEF DESCRIPTION OF THE DRAWINGS

FIG. 1 is a perspective view showing a rope-controlled structure for extended reach garden shears in accordance with an embodiment of the present invention;

FIG. 2 is an exploded perspective view showing a rope-controlled structure for extended reach garden shears in accordance with an embodiment of the present invention;

FIG. 3 is side cross-sectional view showing a rope-controlled structure for extended reach garden shears in accordance with an embodiment of the present invention;

FIG. 4 is a side cross-sectional view of FIG. 3 taken from another viewing angle;

FIG. 5 is a partially enlarged view showing a rope-controlled structure for extended reach garden shears in accordance with an embodiment of the present invention, in which the rope wraps around rollers and pulleys;

FIG. 6 is a schematic view showing the operation of a handgrip of a rope-controlled structure for extended reach garden shears in accordance with an embodiment of the present invention;

FIG. 7 is a schematic view showing the operation of a pull handle of a rope-controlled structure for extended reach garden shears in accordance with an embodiment of the present invention; and

FIG. 8 is a schematic view showing the structure of conventional extended reach garden shears.

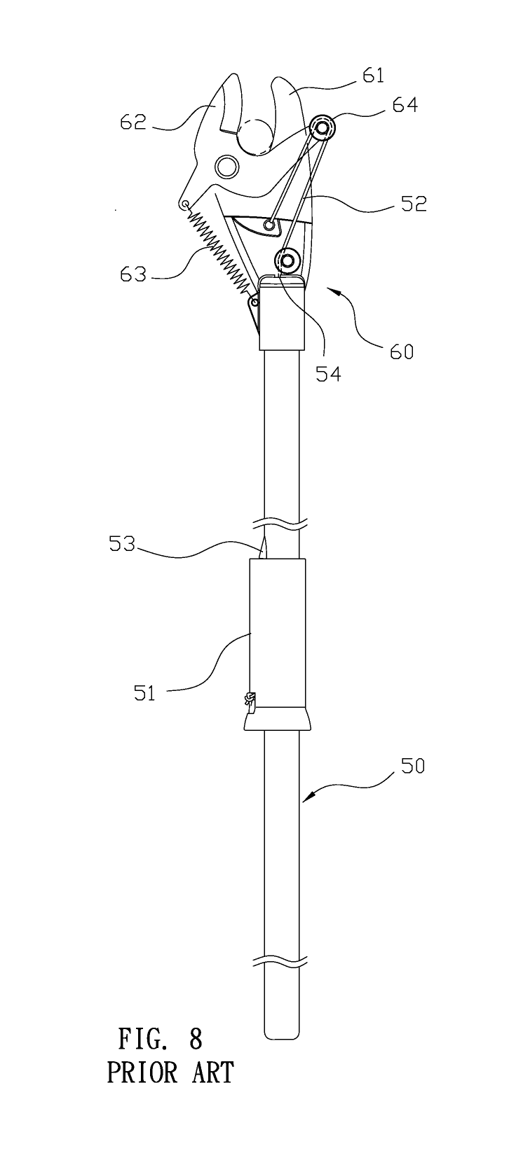

### DETAILED DESCRIPTION OF THE INVENTION

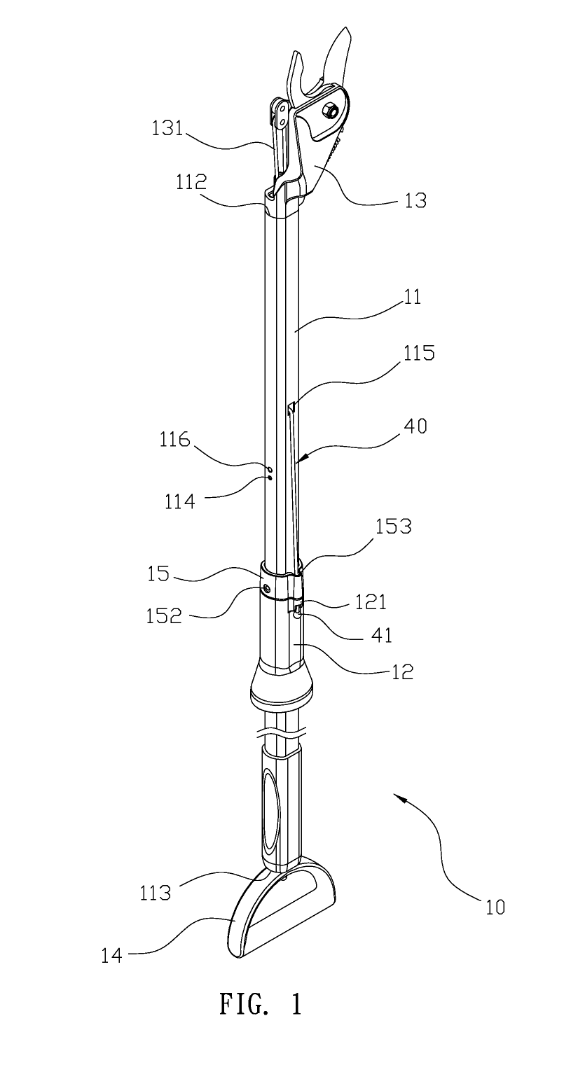

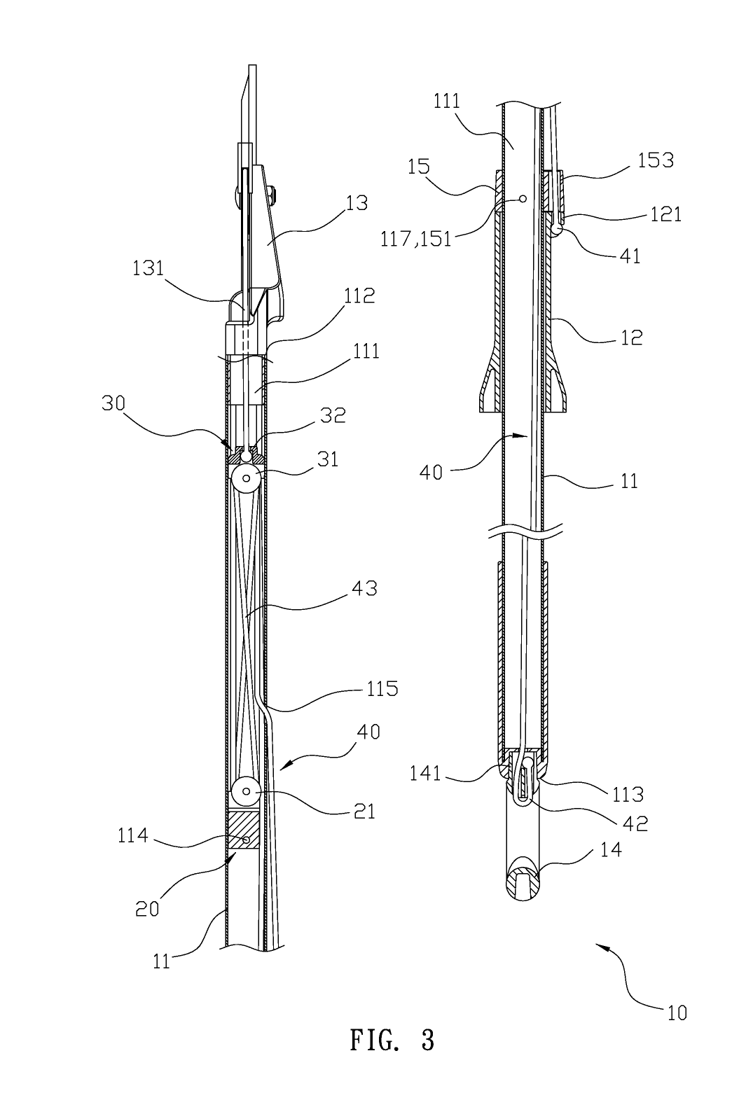

Please refer to FIGS. 1 to 3. An embodiment of the present invention provides a rope-controlled structure for extended reach garden shears, which includes extended reach garden shears 10, a fixed base 20, a movable base 30 and a rope 40. The fixed base 20 and the movable base 30 are mounted within the extended reach garden shears 10. The rope 40 wraps between the fixed base 20 and the movable base 30. The pulling of the rope 40 causes the extended reach garden shears 10 to achieve a trimming action in a labor-saving manner.

The extended reach garden shears 10 comprise an extension rod 11, a handgrip 12, a cutting head 13 and a pull handle 14. The extension rod 11 is formed with an accommodating space 111. Both ends of the extension rod 11 are respectively provided with a front opening 112 and a rear opening 113 in communication with its interior. The extension rod 11 is provided with a pin hole 114 and a rope-guiding hole 115. At least one locking hole 116 is provided near the pin hole 114. The handgrip 12 is slidingly disposed on the extension rod 11 and is provided with a combining portion 121. The cutting head 13 is inserted into the front opening 112 with a control rope 131 extending into the accommodating space 111. The control rope 131 is used to pull the cutting head 13 to generate a trimming action. The pull handle 14 is formed with a connecting portion 141 inserted into the rear opening 113. The extension rod 11 is further provided with a restricting sleeve 15 having a through-hole 151. The extension rod 11 is provided with a fixing hole 117 to correspond to the through-hole 151 of the restricting sleeve 15. A pin 152 is disposed through the through-hole 151 of the restricting sleeve 15 and fixed into the fixing hole 117. The restricting sleeve 15 is used to stop the handgrip 12 to thereby restrict the sliding distance of the handgrip 12. The restricting sleeve 15 is formed with a guide hole 153 in the axial direction of the extension rod 11. The rope 40 is disposed through the guide hole 153, so that the handgrip 12 can pull the rope 40 more smoothly. The fixed base 20 has a plurality of rollers 21 and a through-hole 22. The fixed base 20 is disposed in the accommodating space 111 of the extension rod 11. A pin 23 is disposed through the pin hole 114 and the through-hole 22 and fixed thereto.

The fixed base 20 is provided with at least one elastic protrusion 24. The fixed base 20 is disposed into the accommodating space 11 in such a manner that the protrusion 24 is engaged with the locking hole 116. In this way, the through-hole 22 can be aligned with the pin hole 114 to thereby position the fixed base 20 in the extension rod 11 properly.

The movable base 30 has a plurality of pulleys 31 and a combining portion 32. The movable base 30 is slidingly disposed into the accommodating space 111 of the extension rod 11 with the combining portion 32 being connected to the control rope 131.

The rope 40 has a combining end 41, a connecting end 42 and a wrapping section 43 formed between the combining end 41 and the connecting end 42. The wrapping section 43 wraps around the rollers 21 of the fixed base 20 and the pulleys 31 of the movable base 30. The combining end 41 of the rope 40 extends through the rope-guiding hole 115 of the extension rod 11 to be connected to the combining portion 121 of the handgrip 12. The connecting end 42 of the rope 40 extends through the rear opening 113 to be connected to the connecting portion 141 of the pull handle 14.

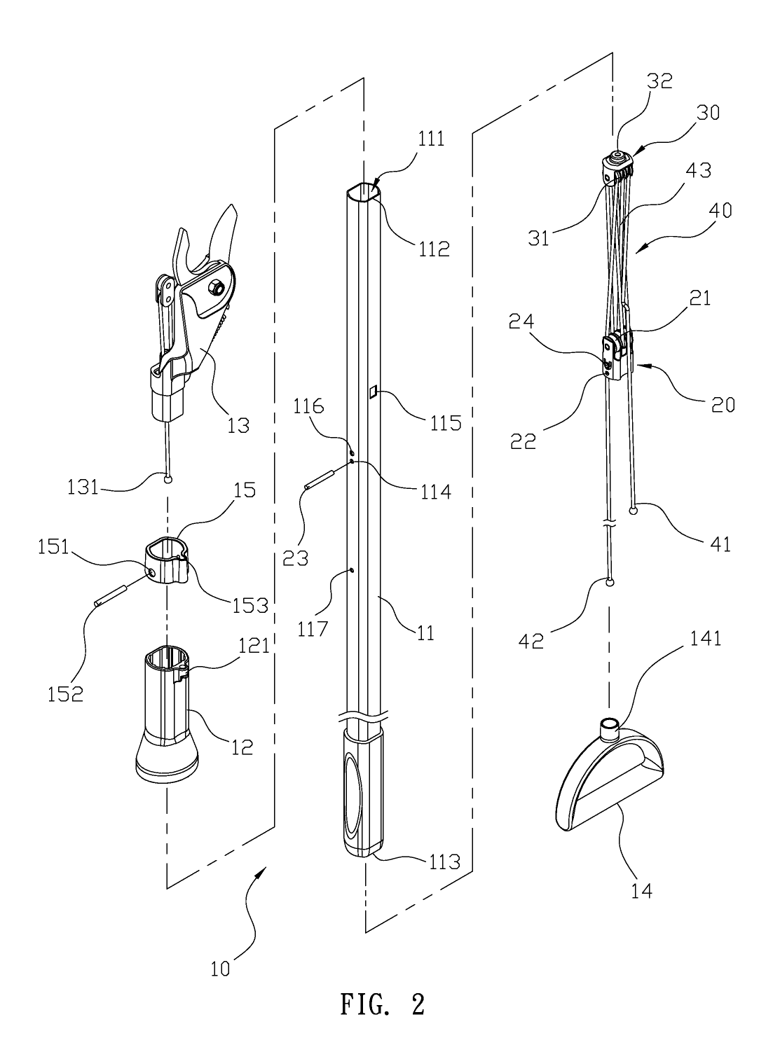

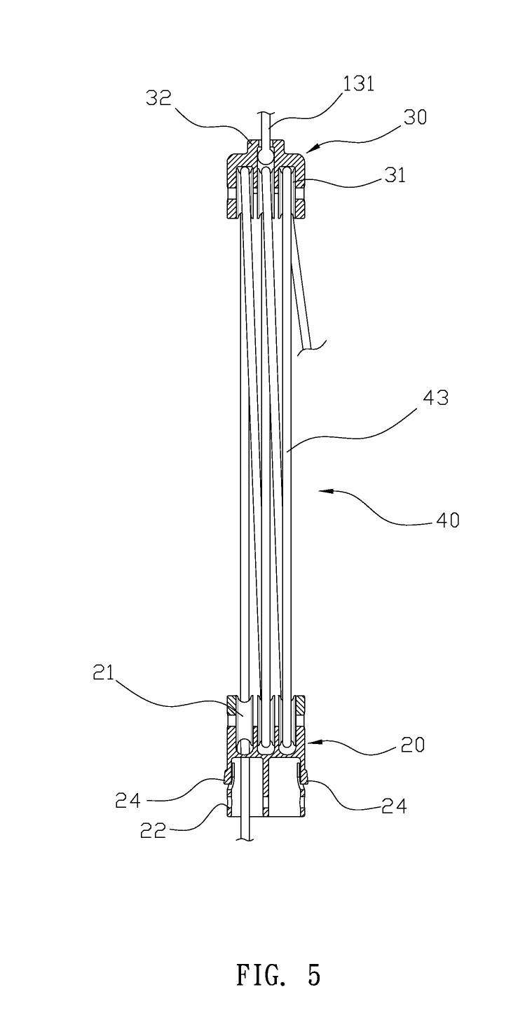

Please refer to FIGS. 2 to 5. The assembly of the embodiment of the present invention will be described as follows. The handgrip 12 and the restricting sleeve 15 are put on the extension rod 11 of the extended reach garden shears 10. The through-hole 151 of the restricting sleeve 15 is aligned with the fixing hole 117. The pin 152 is disposed through the through-hole 151 and the fixing hole 117 for fixing purposes. The wrapping section 43 of the rope 40 wraps around the fixed base 20 and the movable base 30. That is, the wrapping section 43 wraps around the rollers 21 and the pulleys 31. The control rope 131 of the cutting head 13 is connected to the combining portion 32 of the movable base 30. Then, the fixed base 20, the movable base 30 and the rope 40 are disposed into the accommodating space 111 of the extension rod 11. The protrusion 24 of the fixed base 20 is engaged with the locking hole 115, so that the pin hole 114 of the extension rod 11 can be aligned with the through-hole 22 of the fixed base 20. The pin 23 is disposed through the pin hole 114 and the through-hole 22, so that the fixed base 20 can be fixed into the extension rod 11 and the cutting head 13 can be connected to the front opening 112 of the extension rod 11. The combining end 41 of the rope 40 extends through the rope-guiding hole 115 and the guiding hole 153 of the restricting sleeve 15, so that the combining end 41 of the rope 40 can be connected to the combining portion 121 of the handgrip 12. The connecting end 42 of the rope 40 is disposed through the rear opening 113 to be connected to the connecting portion 141 of the pull handle 14. The connecting portion 141 of the pull handle 14 is inserted into the rear opening 113 of the extension rod 11. In this way, the assembly of the present invention is completed.

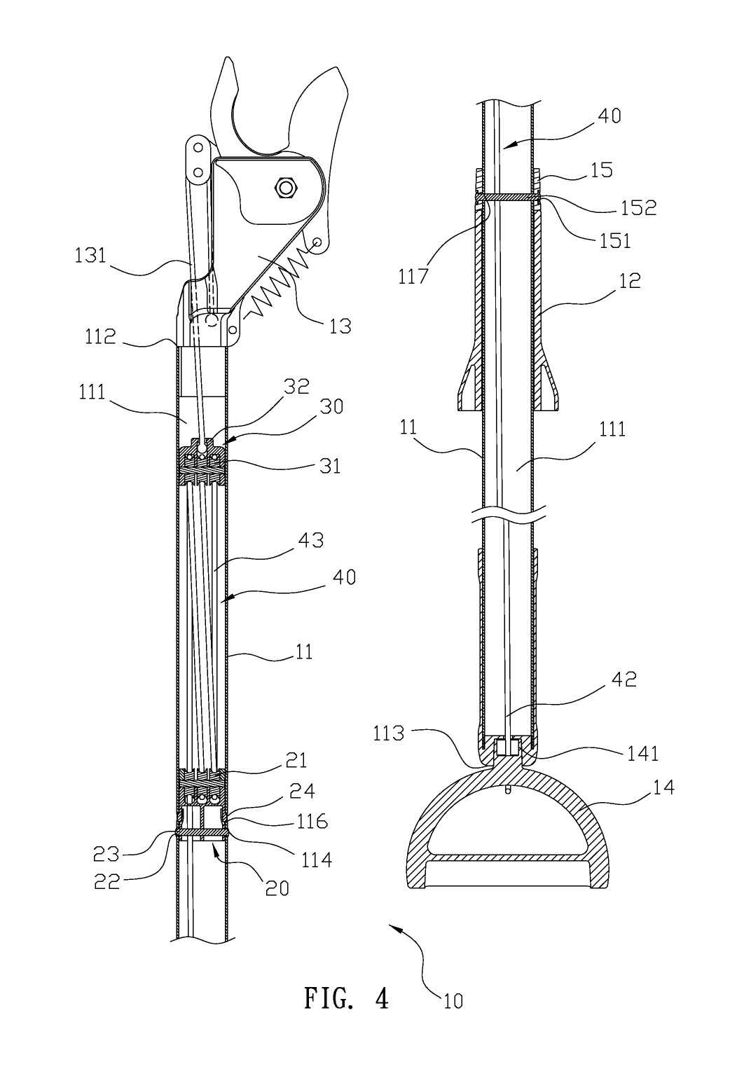

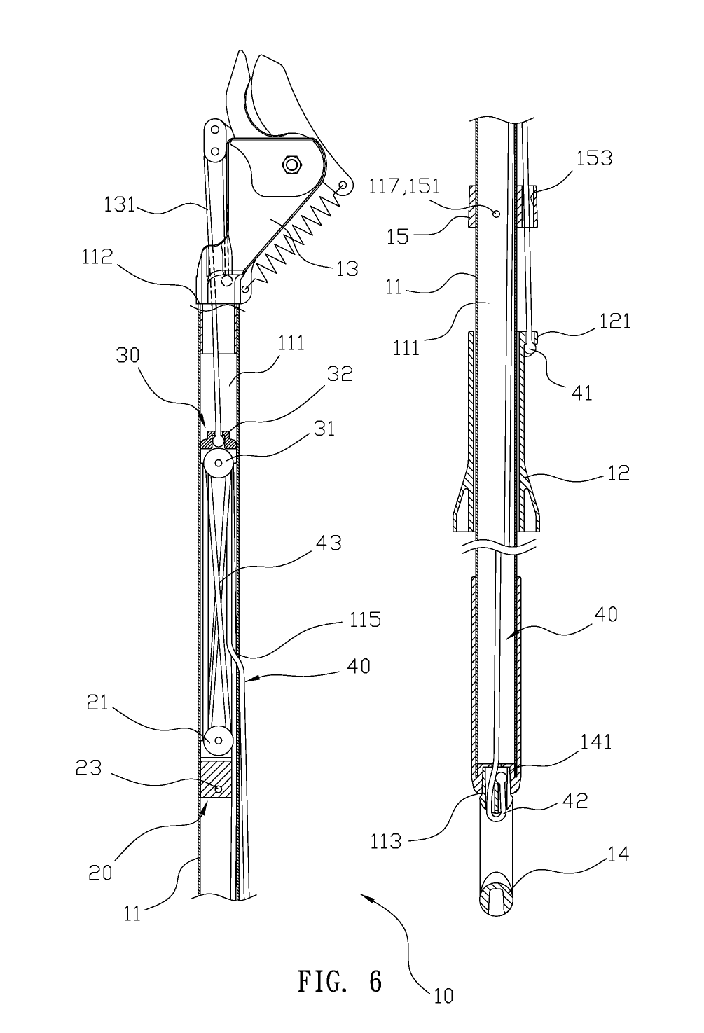

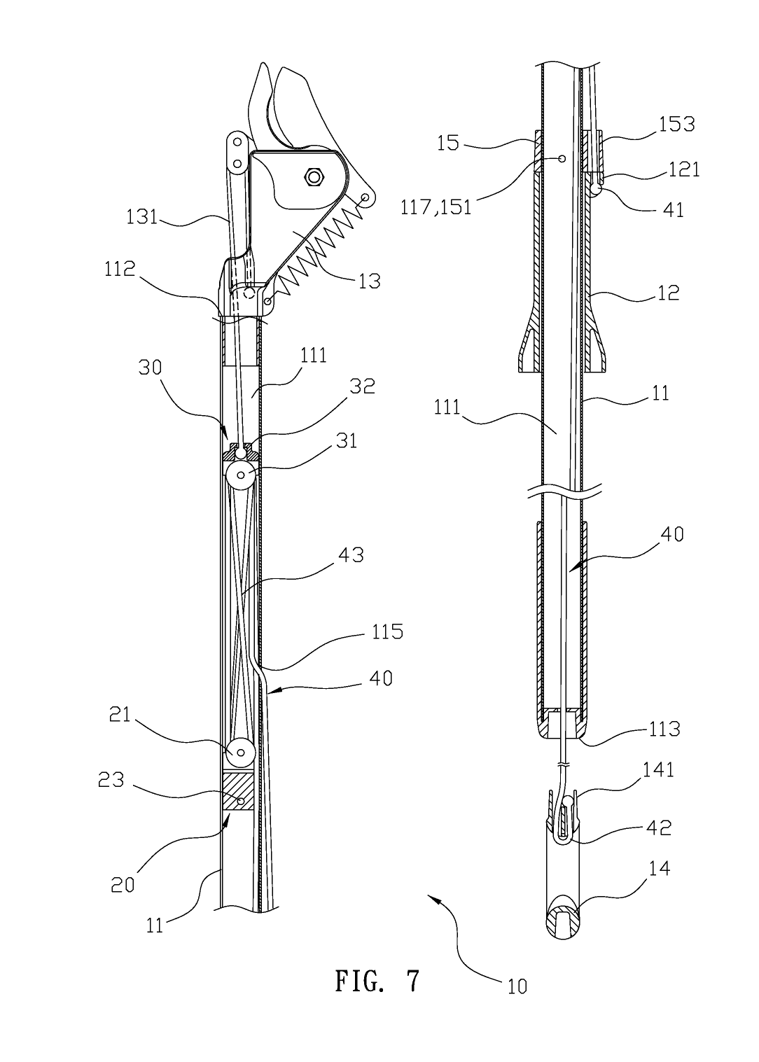

Please refer to FIGS. 6 and 7 together with FIGS. 2 and 4. The operation of the embodiment of the present invention will be described as follows. When a user uses the extended reach garden shears 10 to trim branches or leaves in a tall tree, the user chooses the handgrip 12 or the pull handle 14 to control the extended reach garden shears 10. When the handgrip 12 is pulled to slide along the extension rod 11, the combining portion 121 of the handgrip 12 drives the combining end 41 of the rope 40, so that the rope 40 is pulled to move toward the combining end 41. The connecting end 42 of the rope 40 is connected to the pull handle 14 for fixing purposes. The wrapping section 43 of the rope 40 slides between the rollers 21 and the pulleys 31, thereby causing the movable base 30 to slide toward the fixed base 20. Then, the control rope 131 connected to the movable base 30 drives the cutting head 13 to perform a trimming action. Alternatively, when the pull handle 14 is pulled to move away from the extension rod 11, the connecting portion 141 of the pull handle 14 pulls the connecting end 42 of the rope 40. The combining end 41 of the rope 40 is connected to the handgrip 12 for fixing purposes. The wrapping section 43 of the rope 40 slides between the rollers 21 and the pulleys 31 to cause the movable base 30 to slide towards the fixed base 20. The control rope 131 connected to the movable base 30 drives the cutting head 13 to generate a trimming action.

With the above-mentioned structure, the present invention has the following advantages.

(I) The extended reach garden shears 10 are provided with the extension rod 11. The interior of the extension rod 11 is provided with the fixed base 20 and the movable base 30. The fixed base 20 is provided with a plurality of rollers 21, and the movable base 30 is provided with a plurality of pulleys 31. The rope 40 wraps around the rollers 21 of the fixed base 20 and the pulleys 31 of the movable base 30. The pulling of the rope 40 drives the movable base 30 to slide, thereby causing the cutting head 13 to perform a trimming action. The connection among the rope 40, the fixed base 20 and the movable base 30 can control the trimming action of the extended reach garden shears 10 to achieve a labor-saving effect.

(II) The extension rod 11 is fixedly provided with the restricting sleeve 15, and the restricting sleeve 15 is provided with the guide hole 153 through which the rope 40 is disposed. The guide hole 153 of the restricting sleeve 15 causes the handgrip 12 to pull the rope 40 more smoothly. The restricting sleeve 15 is disposed between the rope-guiding hole 115 and the handgrip 12, thereby restricting the moving distance of the handgrip 12 and facilitating the usage of the present invention.

(III) When the fixed base 20 is disposed into the extension rod 11, the protrusion 24 of the fixed base 20 is engaged with the locking hole 116 of the extension rod 11, so that the through-hole 22 of the fixed base 20 can align with the pin hole 114 of the extension rod 11. In this way, the pin 23 can be easily disposed through the pin hole 114 and the through-hole 22, thereby facilitating the assembly of the present invention.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A rope-controlled structure for extended reach garden shears, comprising:
extended reach garden shears having an extension rod, a handgrip, a cutting head and a pull handle, the extension rod being formed with an accommodating space, both ends of the extension rod being formed respectively with a front opening and a rear opening in communication with its interior, the extension rod being provided with a pin hole and a rope-guiding hole, the handgrip being slidingly disposed on the extension rod, the handgrip being provided with a combining portion, the cutting head being inserted into the front opening, a control rope disposed into the accommodating space for pulling the cutting head to perform a trimming action, the pull handle being formed with a connecting portion inserted into the rear opening;
a fixed base having a plurality of rollers and provided with a through-hole, the fixed base being disposed into the accommodating space of the extension rod, a pin being disposed through the pin hole and the through-hole;
a movable base having a plurality of pulleys and formed with a connecting portion, the movable base being slidingly disposed in the accommodating space of the extension rod, the connecting portion being connected to the control rope; and
a rope having a combining end, a connecting end, and a wrapping section formed between the combining end and the connecting end, the wrapping section wrapping around the rollers of the fixed base and the pulleys of the movable base, the combining end extending through the rope-guiding hole of the extension rod to connect with the combining portion of the handgrip, the connecting end extending through the rear opening of the extension rod to connect with the connecting portion of the pull handle.

2. The rope-controlled structure for extended reach garden shears according to claim 1, wherein the extension rod is provided with a restricting sleeve, the restricting sleeve provided with a through-hole, and the extension rod is provided with a fixing hole corresponding to the through-hole of the restricting sleeve, and a pin is disposed through the through-hole to be fixed into the fixing hole for fixing the restricting sleeve to the extension rod, and the restricting sleeve stops the handgrip to restrict a sliding distance of the handgrip.

3. The rope-controlled structure for extended reach garden shears according to claim 2, wherein the restricting sleeve is formed with a guide hole in an axial direction of the extension rod, and the rope is disposed through the guide hole.

4. The rope-controlled structure for extended reach garden shears according to claim 1, wherein the extension rod is provided with at least one locking hole near the pin hole, the fixed base is provided with at least one elastic protrusion, and the fixed base is disposed into the accommodating space such that the protrusion is engaged with the locking hole and the through-hole is aligned with the pin hole to position the fixed base to the extension rod.
